(19) United States
(12) Patent Application Publication
(10) Pub. No.: US 2009/0284462 A1
(43) Pub. Date: Nov. 19, 2009

(54) COMPUTER WITH VIRTUAL KEYBOARD AND DISPLAY

(75) Inventors: YEN-CHIH CHEN, Tu-Cheng (TW); CHIEN-HENG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/238,417

(22) Filed: Sep. 25, 2008

(30) Foreign Application Priority Data
May 14, 2008 (CN) 200810067167.4

(51) Int. Cl. G09G 5/00

(52) U.S. Cl. 345/156

(57) ABSTRACT

A computer includes a host (10). The host includes an enclosure (11), a circuit board (12) and a projection system (13) both enclosed in the enclosure. The enclosure defines a projection hole (114) therein. The projection system electrically connects with the circuit board. The projection system aligns with the projection hole for projecting information of the computer on a wall via the projection hole. The computer further comprises a virtual keyboard system (15) received in the enclosure. The virtual keyboard system can project a virtual keyboard (16) by which a user of the computer can input data and operate the computer.

### BACKGROUND

1. Technical Field

The present invention generally relates to computers, and particularly to a computer with a virtual keyboard and a virtual display.

2. Description of Related Art

With the continuing development of technology, computers have been widely used in our daily life.

Currently, a typical computer includes a host, a keyboard, a mouse, and a display. However, this computer is very undesirable since the keyboard and display occupy a large space and are not convenient to carry when the computer is required to be moved from one place to another.

What is needed, therefore, is a computer which overcomes the described limitations.

### SUMMARY

A computer includes a host. The host includes an enclosure, a circuit board and a projection system both enclosed in the enclosure. The enclosure defines a projection hole therein. The projection system electrically connects with the circuit board. The projection system aligns with the projection hole for projecting information of the computer on a wall via the projection hole. The host further comprises a virtual keyboard system therein, which can project a virtual keyboard on a top of a desk. By the virtual keyboard, a user can enter data into the computer and operate the computer.

Other advantages and novel features of the present invention will become more apparent from the following detailed description when taken in conjunction with the accompanying drawings.

### BRIEF DESCRIPTION OF THE DRAWINGS

Many aspects of the present computer can be better understood with reference to the following drawings. The components in the drawings are not necessarily drawn to scale, the emphasis instead being placed upon clearly illustrating the principles of the disclosed computer. Moreover, in the drawings, like reference numerals designate corresponding parts throughout the several views.

FIG. 1 is an assembled, isometric view of a computer in accordance with an embodiment of the present invention.

FIG. 2 is similar to FIG. 1, but with a cover of the computer being removed.

FIG. 3 is similar to FIG. 1, but viewed from another aspect.

FIG. 4 is a schematic view showing a working status of the computer of FIG. 1.

### DETAILED DESCRIPTION OF THE EMBODIMENTS

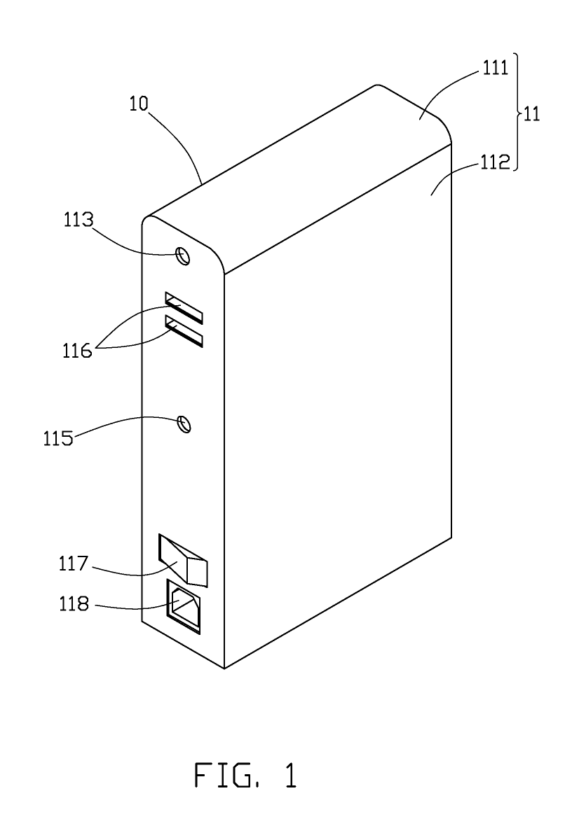

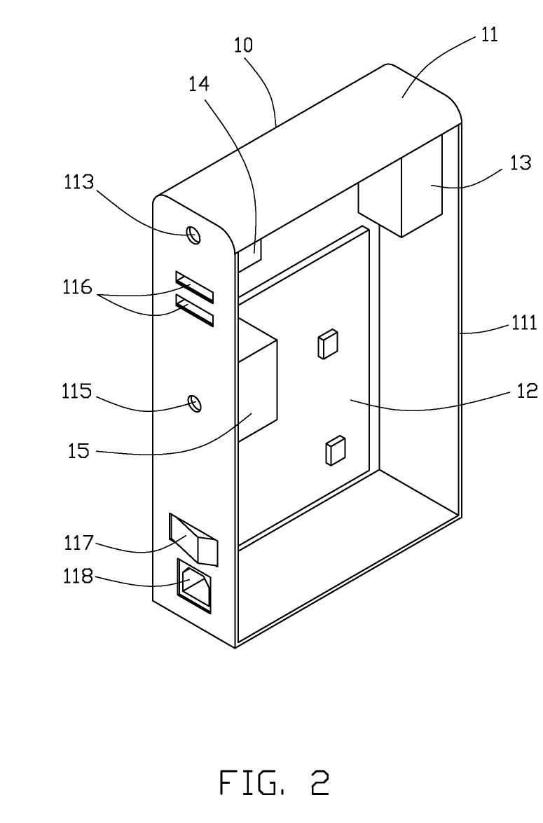

Referring to FIGS. 1 and 2, a computer includes a host 10. The host 10 includes an enclosure 11, a circuit board 12, a projection system 13, a camera system 14, and a virtual keyboard system 15. The circuit board 12, projection system 13, camera system 14, and virtual keyboard system 15 are enclosed in the enclosure 11. The projection system 13, camera system 14, and virtual keyboard system 15 electrically connect with the circuit board 12.

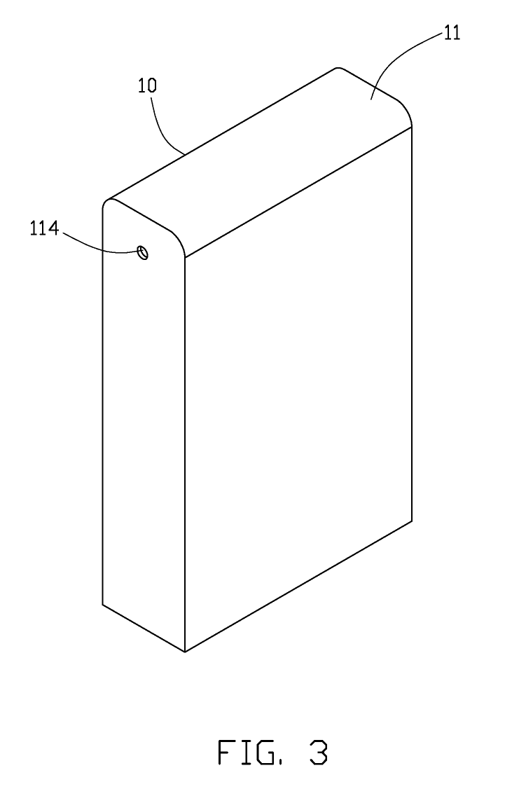

The enclosure 11 includes a housing 111 and a cover 112 engaging a lateral side the housing 111 to cover a lateral opening (not labeled) thereof. The housing 111 defines a camera hole 113, a plurality of universal serial bus (USB) ports 116, a projection orifice 115 and a power supply socket 118 at a front face of the housing 111 along top-to-bottom direction. In addition, a power switch 117 is provided at the front face of the housing 111 between the projection orifice 115 and the power supply socket 118. Referring to FIG. 3, the housing 111 further defines a projection hole 114 at an opposite rear face thereof.

Referring back to FIG. 2, the camera system 14, which preferably is a CCD camera, aligns with the camera hole 113 for picking video and/or image signals, such as a user's image from an outside of the computer via the camera hole 113. The camera system 14 has same structure and operating principle as those of a typical camera system, and can be used for proceeding with a video conference.

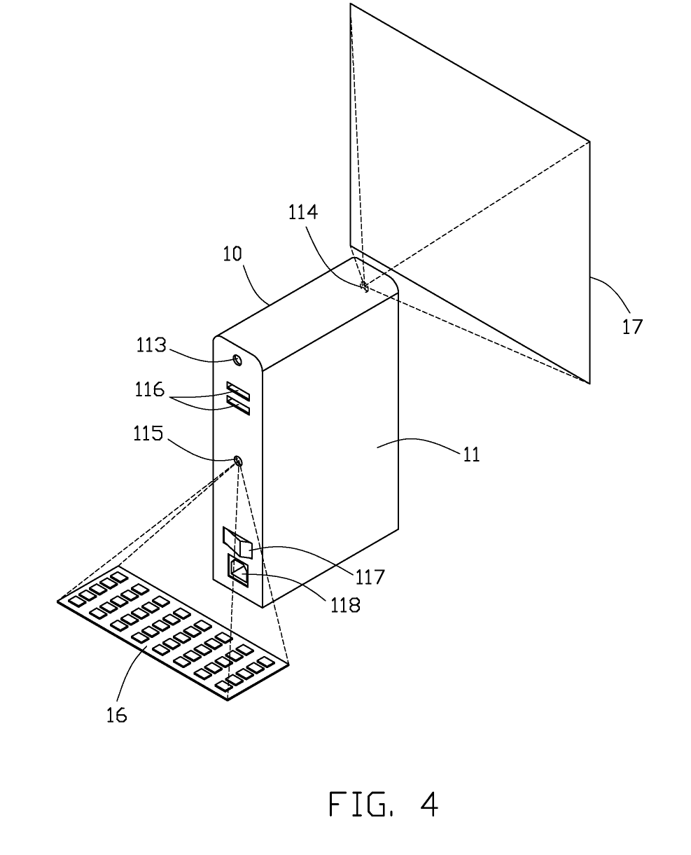

The virtual keyboard system 15 aligns with the projection orifice 115. The virtual keyboard system 15 is used to emit laser lights and thus project a virtual keyboard 16 (shown in FIG. 4) out of the host 111 via the projection orifice 115. The virtual keyboard 16 provides an input environment for users, whereby the users can input signals according to requirements. The virtual keyboard system 15 has same structure and operating principle as those of a typical virtual keyboard system.

The projection system 13 aligns with the projection hole 114, and is used to project information of the computer out of the host 111 via the projection hole 114. The projection system 13 has same structure and operating principle as those of a typical projection system.

Referring to FIG. 4, during operation, the virtual keyboard system 15 emits laser lights and thus projects the virtual keyboard 16 out of the host 11 via the projection orifice 115. Preferably, the virtual keyboard 16 is projected on a top of a desk. Signals are input by the users via the virtual keyboard 16, and are then transmitted from the virtual keyboard 16 to the virtual keyboard system 15 via laser lights emitted by the virtual keyboard system 15. The signals received by the virtual keyboard system 15 are analyzed by the circuit board 12 to which the virtual keyboard system 15 electrically connects. A CPU (not shown) on the circuit board 12 processes the received signals and sends out data in response to the processed signals. The data is transmitted to the projection system 13. The projection system 13 converts the received data into image information, and then projects the image information via the projection hole 114 out of the host 111 to a wall 17 or a projector screen. Thus, the image information is displayed.

In the computer, the projection system 13 and virtual keyboard system 14 are enclosed in the enclosure 11, and the enclosure 11 defines the projection hole 114 and projection orifice 115 aligning with the projection system 13 and virtual keyboard system 14, respectively. Thus, the computer can input and display signals without an additional keyboard and an additional display, which simplifies its structure and reduces its size.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer, comprising:
a host comprising:
an enclosure defining a projection hole therein;
a circuit board enclosed in the enclosure; and
a projection system enclosed in the enclosure and electrically connecting with the circuit board, the projection system aligning with the projection hole for projecting information of the computer out of the host via the projection hole.

2. The computer of claim 1, wherein the enclosure defines a virtual keyboard projection orifice, the host further comprises a virtual keyboard system enclosed in the enclosure and electrically connecting with the circuit board, and the virtual keyboard system aligns with the virtual keyboard projection orifice for projecting a virtual keyboard out of the host via the virtual keyboard projection orifice.

3. The computer of claim 2, wherein the projection hole and virtual keyboard projection orifice are defined at two opposite sides of the enclosure, respectively.

4. The computer of claim 1, wherein the enclosure defines a camera hole, the host further comprises a camera system enclosed in the enclosure and electrically connecting with the circuit board, and the camera system aligns with the camera hole for picking video and/or image signals from an outside of the computer via the camera hole.

5. The computer of claim 1, wherein the enclosure comprises a universal serial bus port, a power supply socket and a power switch at the side of the enclosure at which the virtual keyboard projection orifice is located.

6. A computer comprising:
an enclosure;
a printed circuit board received in the enclosure;
a projection system electrically connecting with the printed circuit board and used for projecting an image information of the computer to an environment through a hole in a rear side of the enclosure; and
a virtual keyboard system electrically connecting the with the printed circuit board and used for projecting a virtual keyboard to the environment through a hole in a front side of the computer.

7. The computer of claim 6 further comprising a camera system received in the enclosure and used for receiving an image from the environment via a hole in the front side of the enclosure.
